(19) United States
(12) Patent Application Publication
(10) Pub. No.: US 2003/0155301 A1
(43) Pub. Date: Aug. 21, 2003

(54) Method of purifying brine

(75) Inventors: James Manio Silva, Clifton Park, NY (US); Paul William Buckley, Scotia, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(73) Assignee: General Electric Company

(21) Appl. No.: 10/036,877

(22) Filed: Jan. 4, 2002

(51) Int. Cl. B01D 15/00

(52) U.S. Cl. 210/660

(57) ABSTRACT

A method of purifying gluconate-containing brine is described which comprises first removing transition metal cations and other impurities by passage of the brine through a first ion exchange resin. The brine is then passed through a second ion exchange resin to effect removal of alkaline earth metal cations. In a third step the brine is treated with a carbonaceous adsorbent to remove impurities introduced by the ion exchange resins, as well as to effect removal of quaternary ammonium salts such as chloromethyl triethylammonium chloride. Methods for the regeneration of the carbonaceous adsorbent are described.

### BACKGROUND OF THE INVENTION

This invention relates to a method for preparing brine that is substantially free of impurities that cause voltage penalties in membrane electrolyzers. More particularly, the method relates to the use of ion exchange resins to remove metal ions from brine solutions using ion exchange resins coupled with the use of one or more polishing steps to remove voltage penalizing impurities introduced into the brine solutions by the ion exchange resins. The method further relates to the regeneration and reuse of the adsorbent materials employed in the brine polishing step.

The manufacture of condensation polymers often produces a brine solution as a by-product. For example, a brine solution is produced in the manufacture of polycarbonate resins through the reaction of phosgene with at least one bisphenol compound in an organic solvent in the presence of aqueous sodium hydroxide. A common example is the reaction of bisphenol A with phosgene in dichloromethane in the presence of aqueous sodium hydroxide to produce bisphenol A polycarbonate and sodium chloride solution, To reduce production costs and avoid environmental pollution, such brine solutions are often recycled to a chlor-alkali plant for electrolysis to produce chlorine gas, sodium hydroxide solution, and hydrogen gas. The electrolysis cells in such chlor-alkali plants frequently comprise an anode compartment and a cathode compartment with an appropriate separator between them. The purpose of the separator is to separate the anolyte solution and catholyte solution within the electrolysis cell. The separator may be at least partially porous to water. The types of separators used in electrolysis cells include diaphragms and membranes.

Electrolyzer membranes and electrodes are sensitive to impurities in the brine, particularly multivalent metal ions. Both cell voltage and current efficiency are sensitive to alkaline earth metals, such as calcium and magnesium. Generally, multivalent metal cations are soluble at the relatively low pH levels on the feed side of the membrane and are thus able to enter the membrane. The cations flow with water and sodium ion from the anode compartment into the membrane toward the cathode. However, because of their limited solubility at the higher pH levels that prevail inside the membrane, the multivalent metal cations precipitate inside the membrane, which causes irreversible damage to the membrane.

Brine solutions arising as by-products from condensation polymer manufacture often contain both organic and inorganic contaminants. Organic contaminants may include residual solvent, catalyst, and aqueous-soluble organic species such as monomer and low molecular weight oligomer. Inorganic contaminants may include multivalent alkaline earth and transition metal cations, particularly iron. When brine solution containing one or more such contaminants is electrolyzed, both organic species and multivalent metal cation species may precipitate on the surface of and within an electrolysis cell separator to cause plugging. To achieve maximum life-time of a separator in an electrolysis cell, the concentration of contaminating organic species and multivalent metal cations must be reduced to as low a level as economically possible in the feed-brine solution.

In some condensation polymer polymerization processes, water soluble chelating agents are employed during the brine forming step. For example, sodium gluconate is frequently present during the interfacial polymerization of bisphenol A with phosgene. A brine produced as a by-product from such a process may contain a substantial amount of sodium gluconate which may in turn present special difficulties during brine recycling in a chlor-alkali plant.

The chlor-alkali industry generally utilizes brine that does not contain chelating agents such as sodium gluconate. For brines free of such organic chelating agents, a relatively simple brine purification process is employed prior to membrane electrolysis. A primary brine treatment is used to reduce brine “hardness”, meaning to reduce the levels of calcium and magnesium ions present in the brine to the 1-2 ppm level. A secondary brine treatment is used to further reduce “hardness” to below about 20 ppb, a commonly employed upper specification limit for alkaline earth metal cations in brine serving as feedstock in a chlor-alkali plant. The secondary brine treatment step typically uses chelating ion exchange resins having a high affinity for alkaline earth metal ions. In the absence of organic chelating agents such as sodium gluconate, membrane-specification hardness levels are readily achieved. Further, silicon and aluminum contaminants may also be removed from chelating agent-free brine by treating said brine with chelating ion exchange resins.

In brines comprising gluconate and multivalent metal ions such as ferric ions and calcium ions, primary brine treatment is also performed, but because of complex metal-gluconate equilibria, further reductions in metal contaminant levels require more complex purification processes. For example, whereas the ferric ion-gluconate interaction is very strong under alkaline conditions, the interaction is considerably weaker at pH 2.5. This pH effect has been utilized to enable multivalent metal ion removal from aqueous streams that contain chelating agents. For example, in the plating industry, aqueous streams containing transition metal cations such as copper and nickel cations are purified by using chelating ion exchange resins. U.S. Pat. No. 4,303,704 describes such a process for the removal of copper and nickel ions at low pH from aqueous mixtures comprising both metal ions and chelating agents.

The use of aminomethyl phosphonic acid (AMP) chelating ion exchange resins has been described for the removal of calcium and magnesium from gluconate-free brine streams. For example, in Journal of Applied Polymer Science, 45 (1992) 173, it is shown that although the equilibrium resin capacity for calcium and magnesium is independent of the brine strength, there is a small negative effect of brine strength on the apparent capacity under packed column conditions. The adsorption kinetics of calcium onto the resin are noted to decrease with increasing brine strength.

Commonly owned, copending application, application Ser. No. 09/378,957, describes a process for achieving membrane-specification hardness levels for gluconate-containing brines. Additionally, U.S. Pat. No. 6,103,092 describes a process for reducing the concentrations of multivalent metal cations in gluconate-containing brines. Finally, U.S. Pat. No. 6,214,235 describes a process for removing haloalkyl trialkylammonium salts (referred to herein as QS) from brine by passage of the brine through an adsorbent which includes a partially pyrolyzed sulfonated polystyrene divinyl benzene, or carbon. As disclosed in, copending application, application Ser. No. 09/378,957, it is critical that transition metal ions such as iron be removed prior to “hardness” removal in order to achieve the membrane specification level of hardness in the brine. Transition metal removal prior to hardness removal also serves to protect the hardness removal resins from being fouled by irreversible ion exchange of transition metals onto resin.

The various brine purification schemes discovered to date rely upon the use of ion exchange resins to reduce the concentration of brine hardness ions such as calcium and magnesium, transition metal multivalent ions such as iron and nickel cations, and other polyvalent metal cations such as aluminum cations, to acceptable levels prior to its use as feed for the electrolyzer cells of a chlor-alkali plant. While known brine purification schemes employing ion exchange resins should enable the recycling of brines produced in interfacial polymerization reactions, such recycle brines are electrolyzed with considerably less efficiency than are fresh (non-recycle) brine solutions. Thus, the use of recycled brines purified using known purification schemes employing ion exchange resins can be thought of as exacting a “voltage penalty” during electrolysis, the magnitude of this voltage penalty being the difference in voltage between electrolysis of recycle brine solutions and electrolysis of non-recycle brine solutions. Thus there is a continued need to reduce the voltage penalty incurred in the electrolysis of recycle brines, particularly with membrane electrolyzes.

### BRIEF SUMMARY OF THE INVENTION

It has been discovered that even after primary and secondary brine treatment, treated recycle brine still demonstrates serious voltage penalties during electrolysis in membrane electrolyzers. While not being bound by theory, it is hypothesized that these resins, particularly in the presence of recycle brine, release low levels of contaminants, said contaminants being referred to herein as “resin extract”. It is also hypothesized that there are organic contaminants in the recycle brine that are not removed by either primary brine treatment or by the ion exchange resins. We have also discovered that by adding a polishing step downstream of these ion exchange resins, the voltage penalty is substantially eliminated. Brine that is a by-product of an interfacial polycarbonate manufacturing process employing a trialkylamine catalyst, such as triethylamine, and methylene chloride solvent, frequently contains a chloromethyl quaternary ammonium salt (QS), which must be removed from the brine prior to its use as a feedstock for a chlor-alkali plant. We have discovered that by performing QS adsorption as a polishing step after ion exchange, we are able to remove QS, the contaminants released by the ion exchange resins, and possibly other unknown contaminants, thereby significantly reducing voltage penalties in membrane electrolyzers. This process has been successfully demonstrated for recycle brines that contain 100-350 ppm sodium gluconate and for brines made from salt containing no gluconate.

In one aspect, the invention relates to a method for removing impurities from a brine solution, the brine solution comprising a water soluble chelating agent, the method comprising the steps of:

a) adjusting the pH of the brine solution to a pH of from about 2 to about 4 and passing the brine solution through a first functionalized resin; said first functionalized resin having functional groups capable of removing transition metal cations from the brine solution;

b) adjusting the pH of the brine solution to a pH of from about 9 to about 11.5 and passing the brine solution through a second functionalized resin, said second functionalized resin having functional groups capable of removing alkaline earth metal cations from the brine solution; and

c) subjecting the brine solution to a polishing step following step b).

In a further aspect aspect, the present invention relates to the regeneration of absorbent materials employed in the polishing step.

### DETAILED DESCRIPTION OF THE INVENTION

The present invention may be understood more readily by reference to the following detailed description of preferred embodiments of the invention and the examples included herein. In this specification and in the claims which follow, reference will be made to a number of terms which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

As used herein the term brine polishing refers to passage of a brine through a carbonaceous adsorbent medium other than an ion exchange resin.

“BPA” is herein defined as bisphenol A and is also known as 2,2-bis(4-hydroxyphenyl)propane, 4,4′-isopropylidenediphenol and p,p-BPA.

As used herein, the term “bisphenol A polycarbonate” refers to a polycarbonate in which essentially all of the repeat units comprise a bisphenol A residue.

The recycle brine solutions as contemplated in the present invention may be obtained as a by-product of a manufacturing process, such as a condensation polymer manufacturing process. Condensation manufacturing processes that may produce brine as a by-product include, but are not limited to, condensation processes that produce polycarbonates, polyesters, polyarylates, polyamides, polyamideimides, polyetherimides, polyethersulfones, polyetherketones, polyetheretherketones, polyarylene sulfides, polyarylene sulfidesulfones, and the like.

In a polycarbonate production process, for instance, aqueous sodium chloride arises as a by-product when at least one bisphenol is reacted in an organic solvent with phosgene or a carbonate precursor such as an oligomeric carbonate chloroformate in the presence of an aqueous alkaline earth metal hydroxide, such as aqueous sodium hydroxide to produce a polycarbonate, for example as in U.S. Pat. No. 4,737,573. Representative polycarbonate and polycarbonate copolymers that can be made by such a process include, but are not limited to, bisphenol A polycarbonate; 3,3′,5,5′-tetramethyl bisphenol A polycarbonate; 3,3′,5,5′-tetrabromo bisphenol A polycarbonate, and mixtures thereof.

Before recycling to an electrolysis cell, the concentration of the alkali metal halide in the brine solution, for instance sodium chloride, may be adjusted to obtain the most efficient operation of the cell. The sodium chloride concentration, for instance, may be increased by the addition of make-up salt. Make-up salt is sodium chloride obtained, for example, from natural ground deposits or from evaporation of sea water.

In the brine solution which is subjected to purification, the amount of sodium chloride in solution ranges from a concentration of about 50 grams per liter (gpl) of solution to about that concentration at which the solution is saturated with sodium chloride at a given temperature. Preferably, the sodium chloride concentration ranges from about 180 to about 320 grams per liter of solution, more preferably from about 280 to about 310 grams per liter of solution.

Typically, the brine solution by-product is separated from the condensation polymer product and is then subjected to various treatment steps to increase the concentration of sodium chloride and to remove contaminants. Such “recycle brine” then serves as feedstock for the electrolysis cells of a chlor-alkali plant. Suitable electrolysis cells may comprise an anode compartment and a cathode compartment with an appropriate separator between the two compartments to separate the anolyte solution and the chlorine gas evolved at the anode from the catholyte solution and the hydrogen gas evolved at the cathode within the cell. Optionally, the separator may be at least partially porous to water. Commonly, membrane separators are used to the separate the anode compartment and the cathode compartment.

A membrane chlor-alkali electrolyzer has two compartments (an anode compartment and a cathode compartment) separated by a membrane. The brine solution is introduced into the anode compartment, and deionized water is introduced into the cathode compartment, followed by application of electrical current across the membrane electrolyzer. This process electrolyzes the sodium chloride from the brine solution and yields a caustic solution as the liquid product exiting the cathode compartment. Details of this process are given by Curlin, L. C, Bommaraju, T. V., and Hansson, C. B., Alkali and Chlorine Products: Chlorine and Sodium Hydroxide, Kirk-Othmer Encyclopedia of Chemical Technology, Fourth Edition, Volume 1, pp. 938-1025 (1991).

Membrane separators may comprise an ion exchange resin which selectively passes alkali metal cations, but not anions, from the anolyte solution to the catholyte solution and which substantially retards back-migration of hydroxide anions from the catholyte solution to the anolyte solution.

During operation of a membrane electrolysis cell, solid species may gradually accumulate on the surface of and within the membrane. This causes a general performance decline, in which the current efficiency decreases and the cell voltage increases, resulting in increased power consumption per unit chlorine production. The effects of impurities on membrane cells are documented in a report published by DuPont, “Effect of Impurities on Membrane for Chloralkali Production”, James T. Keating, E. I. DuPont de Nemours and Company, Wilmington, Del., USA.

To maximize membrane lifetime and efficiency of electrolysis cell operation, the recycle brine solution is subjected to purification steps to remove contaminants before electrolysis. Contaminants include both those from the polymer manufacturing process and those from make-up salt, which is often added to brine that is recycled from the polymer manufacturing process. Typical contaminants include phenolic species, organic catalyst and solvent residues, and metal species such as alkaline earth and transition metal cations. Purification steps to remove contaminants include one or more steps of referred to as primary and secondary brine treatment. Primary brine treatment comprises the addition of carbonate and hydroxide ion to precipitate metals, clarification, filtration, volatiles stripping, and contact with an adsorbent to remove organic impurities. Secondary brine treatment is performed prior to feeding the brine to a membrane electrolyzer and includes treatments such as ion exchange to reduce the concentration of multivalent metal cations. Phenolic species present as contaminants in recycle brine are illustrated by bisphenols such as BPA, monophenols such as phenol and p-cumylphenol, trisphenols such as 1,1,1-tris(4-hydroxyphenyl)ethane (THPE). Organic catalyst and solvent residues present as contaminants in recycle brine are illustrated by free tertiary amines such as triethylamine, phase transfer catalysts such as quaternary ammonium salts sometimes used during the preparation of polycarbonate, free solvent such as dichloromethane, and chlorobenzene, and quaternary ammonium salt products formed by reaction of free amine catalyst with the solvent. Quaternary ammonium salt products arising from reaction of free tertiary amine catalyst with solvent are illustrated by chloromethyltriethyl ammonium chloride. Quaternary ammonium salts arising from the reaction of the tertiary amine catalyst and the solvent used in the polymerization reaction typically have structure I

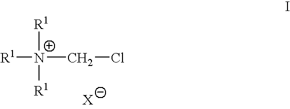

wherein each R¹ is independently at each occurrence a C₁-C₁₀ aliphatic radical, a C₃-C₁₀ cycloaliphatic radical, or a C₄-C₁₀ aromatic radical.

Quaternary ammonium salts (QS) I are illustrated by chloromethyl triethylammonium chloride, chloromethyl tripropylammonium chloride, chloromethyl dibutyl methyl ammonium chloride, and the like.

Alkaline earth metal cations that are often present in the raw brine solution include calcium and magnesium. These species are often referred to as “hardness”. The calcium and magnesium concentrations in the raw brine solution may each independently be in the range of about 0.005 parts per million (ppm) to about 2000 ppm, more often in the range of about 0.005 ppm to about 400 ppm, and still more preferably in the range of about 0.005 ppm to about 10 ppm. For maximum membrane lifetime and efficiency of electrolysis cell operation the sum of the concentrations of both calcium and magnesium in the purified electrolyzer feed brine solution is most preferably less than about 20 parts per billion (ppb).

Multivalent cations, such as transition metal cations, that are often present in the raw brine solution include iron, chromium, and nickel. The iron, chromium, and nickel concentrations in the brine solution prior to the purification process of the invention are typically found to be present in the range of about 0.001 ppm to 100 ppm, or in the range of about 0.001 ppm to about 10 ppm, or in the range of about 0.001 ppm to about 2 ppm. For maximum membrane lifetime, maximum efficiency of membrane electrolyzer operation, and to enable achievement of membrane-specification hardness levels during subsequent hardness removal treatment, the concentrations of iron and chromium in the purified brine solution must be each independently less than about 0.1 ppm and the concentration of nickel in the purified brine must be below about 10 parts per billion (ppb). In particular, it was found that the presence of iron in the feed brine precludes achieving membrane-specification hardness levels in the purified brine and causes fouling of hardness removal ion exchange resins.

Brine solutions, as contemplated in the present invention, may also contain a water-soluble metal chelating agent which may form water-soluble complexes with multivalent metal cations, particularly transition metal cations. Typical water-soluble chelating agents include N,N,N′,N′-ethylenediamine-tetraacetic acid (EDTA), nitrilotriacetic acid (NTA), gluconic acid, and their sodium salts. Sodium gluconate is a frequently encountered water soluble chelating agent present in brine solutions which may be purified according to the method of the present invention. It is generally preferred that the concentration of water-soluble metal chelating agent in the brine solution prior to the purification process of the invention be less than about 2000 ppm, preferably less than about 500 ppm, and still more preferably less than about 200 ppm. Typically, the concentration of sodium gluconate in the brine solution is in a range between about 50 and about 500 ppm.

In general, membrane separators are more sensitive to contaminants than diaphragm separators. Impurities which affect membrane cell performance and which may be present in the brine from a condensation polymerization process include, but are not limited to, calcium, magnesium, strontium, barium, nickel, mercury, aluminum, iron, and silica.

Impurities have different effects on the membrane and different amounts of the various impurities may be present before the system is fouled. For instance, calcium and magnesium at about 20 parts per billion (ppb) will begin precipitating in the membrane as hydroxides. Strontium at about 500 ppb will begin precipitating in the membrane. Barium at about 1 part per million (ppm) will begin precipitating in the membrane, Sodium sulfate at concentrations of about 10 grams/liter result in a decline in the efficiency of the cell.

Prior to the brine purification process, as contemplated in the instant invention, the raw brine solution, from a condensation polymerization reaction, for instance, preferably undergoes a “primary brine treatment”. Primary brine treatment helps to minimize the impurities in the brine solution before a “secondary brine treatment”, said secondary brine treatment comprising the steps of the present invention.

In primary brine treatment, the brine pH is elevated to above about 10 in the presence of a molar excess of carbonate ion in order to precipitate alkaline earth and transition metals as their carbonates and/or hydroxides, followed by a filtering and/or settling process such as clarification. This is followed by acidification and stripping of the brine to remove carbonate ion as well as volatile organic contaminants such as organic solvents and dissolved catalysts. Additional treatment such as adsorption may be utilized as necessary to remove organic species such as monomer and low molecular weight oligomers from the brine. Experimental details for carrying out primary brine treatment in this manner are described in U.S. Pat. No. 6, 103, 092.

In the secondary brine treatment phase, it was earlier discovered that that if transition metals were removed first from the brine undergoing treatment, the ion exchange process for alkaline earth metal removal was observed to occur with greater efficiency and membrane specification levels (i.e. less than 20 parts per billion (ppb)) of alkaline metal ions in the brine were achievable. It has now been discovered that the incorporation of a brine “polishing” step into this secondary brine treatment following ion exchange removal of alkaline earth metal cations significantly reduces the voltage penalty observed when recycle brines are employed in membrane electrolyzers.

The method of the present invention typically is carried out following primary brine treatment and comprises the following steps: (a) ion exchange resin mediated removal of transition metal cations at low pH; (b) alkaline earth metal cation removal at higher pH; and (c) brine polishing. In step Step (a) the brine is treated with a first chelating ion exchange resin, typically an imino diacetic acid (IDA)—functionalized polystyrene ion exchange resin, at low pH (2.5-3.5) to remove transition metal cations; primarily iron and nickel cations. In addition, trivalent cations such as aluminum cations may be removed in step (a). Step (a) plays a critical role in removing transition metal cations in order to avoid contaminating a second ion exchange resin employed in Step (b), typically an AMP-functionalized resin, with transition metal cations such as iron. In step (b) the pH of the brine is increased to about 9-11 and the brine is then passed through the second ion exchange resin to remove hardness from the brine. Step (c) follows Steps (a) and (b) and is referred to as a “brine polishing step”. In step (c) the brine is treated in a synthetic or natural carbon adsorbent bed, thereby removing QS, organic contaminants extracted from the ion exchange resins, and other organic compounds contained in the brine. It is noted that Step (c) is known to not be effective in removing sodium gluconate from brine. Steps (a), (b) and (c) are also referred to as the first, second, and third “stages” of the brine purification process described by the instant invention.

In the first stage (step (a)) of the process of the present invention, the pH of a gluconate-containing brine solution is adjusted from its initial pH to a pH of from about 2 to about 4, more preferably about 2.5 to about 3.5, even more preferably about 2.5. The initial pH is typically weakly alkaline, pH 8-10, which is common for brine after primary brine treatment. Typical means of adjusting the pH to the desired range include addition to the brine solution of a sufficient amount of at least one mineral acid. Hydrochloric acid is particularly preferred in the application of the present invention.

Following adjustment of the pH, the brine solution is then intimately contacted with at least one resin bed comprising a first functionalized resin. The first functionalized resin may be any resin capable of removing transition metal cations, including but not limited to, iron and nickel cations, as well as other multivalent cations such as aluminum cations.

Ion exchange resins suitable as the first functionalized resin include, but are not limited to chelating ion exchange resins. Chelating ion exchange resins that are effective for iron removal include iminodiacetic acid functionalized resins (IDA) and aminomethyl phosphonic acid (AMP) functionalized resins. Although AMP functionalized resin has about 20% more iron capacity than IDA, only about 13 to about 25% of the iron loaded onto AMP resin is recovered during regeneration. For this reason, IDA functionalized resins are preferred.

Commercially available IDA resins such as AMBERLITE IRC-718, manufactured by Rohm & Haas Co. or LEWATIT TP207, manufactured by Bayer, may be used in the first functionalized ion exchange resin bed.

The first functionalized resins preferably have an ion exchange capacity from about 0.1 milliequivalents of metal ion per milliliter of resin to about 3 milliequivalents of metal ion per milliliter of resin, and preferably from about 0.5 milliequivalents of metal ion per milliliter of resin to about 1.5 milliequivalents of metal ion per milliliter of resin.

Contacting a brine solution in the first functionalized ion exchange resin bed may be performed by methods known in the art, such as batch, continuous, or semi-continuous methods. In a preferred method, the brine solution is passed through a vessel, such as a column, containing a bed of the first functionalized ion exchange resin. Passage of brine through the resin bed may continue until the metal ion complexing capacity of the resin bed is substantially exhausted as shown by an increase in the concentration of contaminating metal ions in brine solution exiting the vessel containing the resin bed. When the metal ion complexing capacity of a resin bed is exhausted, then a fresh resin bed is employed for treatment of further brine solution. Exhausted ion exchange resin beds may be regenerated according to methods known in the art. These include, for example, acid treatment to strip cations from the resin bed followed by base treatment to return the resin to the sodium form prior to being placed back into service. Ion exchange processes are described by C. Dickert in “Ion Exchange” Kirk-Othmer Encyclopedia of Chemical Technology, fourth edition, vol. 14, pp. 760-770 (1995).

In the first stage, the brine is intimately contacted with the first functionalized ion exchange resin bed in a continuous or semi-continuous process. Typically the flow rate of brine through the resin bed ranges from about 1 resin bed volumes per hour to about 30 resin bed volumes per hour. Preferably the flow rate in a continuous process is in the range of about 8 resin bed volumes per hour to about 25 resin bed volumes per hour. As used in the present invention, a flow rate expressed as 10 resin bed volumes per hour indicates, for example, that 5 gallons of the brine solution is contacted with 0.5 gallons of a chelating ion exchange resin per hour. The temperature for contacting the brine solution with the ion exchange resin bed ranges from about 20° C. to about 90° C., preferably from about 40° C. to about 70° C., and more preferably about 55 to about 65° C.

The brine solution recovered from treatment with the first functionalized ion exchange resin contains a significantly reduced concentration of transition metal cation contaminants. The amount of transition metal and other multivalent cations, (e.g. Al⁺³), that is removed depends, among other factors, upon the initial metal cation contaminant concentrations, the pH to which the brine solution is adjusted, the temperature of the brine as it passes through the ion exchange resin bed, and the space velocity (i.e. the number of resin bed volumes of brine per hour) at which the brine contacts the first functionalized ion exchange resin.

Typically, the concentrations of iron, chromium, and nickel cations are each reduced to below their detection limits in the brine solution following contact with the first functionalized ion exchange resin. This is surprising in view of the strong interaction between the metal cations and gluconate. Because of this strong interaction, a fraction of multivalent metal cation contaminants removed from the thus treated brine was present in the form of water-soluble complexes with a metal chelating agent. In particular, a substantial fraction of the iron removed as a contaminant from the thus treated brine solution was initially present in the form of a water-soluble gluconate complex.

After the passage of the brine through the first functionalized resin, the pH of the brine solution is readjusted to a pH range of from 9 to about 11.5. Typical means of adjusting the pH to said range include one or more steps of addition to the brine solution of a sufficient amount of an alkali metal compound, such as an alkali metal hydroxide.

Suitable alkali metal compounds which may be used to adjust the pH in the brine solution include, but are not limited to, sodium hydroxide, potassium hydroxide, lithium hydroxide or a mixture thereof. Sodium hydroxide is preferred.

Following the adjustment of the brine solution to a pH of from about 9 to about 11.5, preferably to about 10, the brine is intimately contacted with a second functionalized ion exchange resin bed in a batch, continuous, or semi-continuous process and the flow rate of brine through the resin bed ranges from about 1 resin bed volume per hour to about 30 resin bed volumes per hour (i.e. at a space velocity of from about 1 to about 30 bed volumes per hour), more preferably between about 5 resin bed volumes per hour and about 15 resin bed volumes per hour. The brine is preferably passed through the second functionalized ion exchange resin bed at a temperature of from about 20° C. to about 90° C., preferably from about 40° C. to about 70° C., and more preferably from about 55° C. to about 65° C.

The second functionalized ion exchange resin acts to remove the “hardness” from the brine solution. As used herein, “hardness” refers to alkaline earth metal cations, including but not limited to cations of calcium, magnesium, barium, strontium or mixtures thereof. The second functionalized resin may be any resin capable of removing hardness. Amino methyl phosphonic acid functionalized (AMP) ion exchange resins are preferred. Suitable AMP resins include DUOLITE 467, manufactured by Rohm and Haas company and LEWATIT OC 1060, manufactured by Bayer.

Although hardness is primarily removed in the second ion exchange resin treatment stage, the first stage, comprising adjustment of the pH to from about 2 to about 4 and passage of the brine solution through a first functionalized resin, serves to protect the AMP resin from iron contamination, as iron binds essentially irreversibly to AMP resin.

Contact of the brine solution with the second functionalized ion exchange resin may be performed by methods known in the art, such as batch, continuous, or semi-continuous methods. In a preferred method, the brine solution is passed through a vessel containing a bed of the second functionalized ion exchange resin. Passage of brine through the vessel may continue until the capacity of the resin bed is substantially exhausted as shown by an increase in the concentration of contaminating alkaline earth metal cations in the brine solution exiting the vessel. When the metal ion complexing capacity of a resin bed is exhausted, then a fresh resin bed is employed for treatment of further brine solution. Exhausted ion exchange resin beds may be regenerated according to methods known in the art.

The third stage comprises intimately contacting the brine, previously treated in the first and second stages of the process, with a carbonaceous adsorbent. Generally it is preferred that the brine be contacted with the carbonaceous adsorbent by passing the brine through a fixed bed of said carbonaceous adsorbent. The contact may be carried out in a continuous or semi-continuous mode. Typically, the brine is passed through a fixed bed of the carbonaceous adsorbent at a flow rate of brine through the resin bed in a range from about 1 resin bed volumes per hour to about 30 resin bed volumes per hour (i.e. a space velocity of from about 1 to about 30 bed volumes per hour). Preferably the flow rate in a continuous process is in the range of about 8 resin bed volumes per hour to about 25 resin bed volumes per hour. The temperature for contacting the brine solution with the carbonaceous adsorbent ranges from about 20° C. to about 90° C., preferably from about 40° C. to about 70° C., and more preferably about 55 to about 65° C.

Although pyrolyzed sulfonated polystyrene divinylbenzene, for example AMBERSORB 572 (Rohm and Haas Co.), has been found to be most effective for brine polishing, a wide variety of carbonaceous materials may be used. These carbonaceous materials are illustrated by activated carbons such as activated carbons, and unfunctionalized polystyrene resins. Activated carbons are illustrated by CALGON CPG and CALGON FLTRASORB adsorbents, and coconut-shell derived carbon adsorbents. Unfunctionalized polystyrene resins are illustrated by XAD-4 (Rohm and Haas Co.).

When brine solution from a polymer manufacturing process (a recycle brine) treated by the method of the present invention is electrolyzed in a membrane electrolysis cell, the cell exhibits a significantly reduced voltage relative to the voltage observed for electrolysis of a recycle brine purified without the final brine polishing step. The reduced voltage resulting from the brine polishing step is believed to result from a reduction in the level of voltage penalizing contaminants introduced into the brine during the ion exchange steps of the process, step (a) and step (b) as well as from a reduction in other brine contaminants such as QS, In addition, the ion exchange steps of the process serve to reduce the deposition on the surface of and within the membrane separator, of solid species derived from contaminating multivalent metal cations otherwise present in the brine solution. In particular, a membrane separator in an electrolysis cell exhibits a significantly longer lifetime using brine treated by the method of the present invention, particularly when operating with gluconate-containing recycle brine.

An important function of step (c) of the method of the present invention is the removal of quaternary ammonium salt (QS) which may be present in the recycle brine before purification. As a brine containing QS is treated in step (c) the carbonaceous adsorbent gradually becomes saturated with QS. This results in QS “breakthrough” leading to an unacceptably high level of QS in the treated brine. At this point fresh carbonaceous adsorbent must be employed. As has been mentioned, the first and second ion exchange resins employed according to the method of the present invention may be regenerated for reuse using known techniques. It would be highly desirable that the carbonaceous material employed in the brine polishing step be capable of being regenerated for reuse. Because the carbonaceous adsorbent employed in the brine polishing step does not function as ion exchange resin, means other than those used for the regeneration of the first and second ion exchange resins are required for its regeneration. In one aspect then, the present invention provides, in addition to a brine purification method comprising a brine polishing step, a method for the regeneration and reuse of the carbonaceous adsorbent employed in the brine polishing step.

In one embodiment the present invention provides a method for regenerating a carbonaceous adsorbent, said adsorbent comprising one or more adsorbed quaternary ammonium salts, said method comprising the step of contacting the carbonaceous adsorbent with a regeneration liquid. A regeneration liquid is defined as a liquid in which said quaternary ammonium salt is appreciably soluble. By appreciably soluble it is meant that the quaternary ammonium salt is soluble to at the extent of at least 0.1 percent, preferably at least 1 percent and still more preferably at least 10 percent by weight at equilibrium. The contact between the carbonaceous adsorbent and the regeneration liquid is carried out for a period of time sufficient to allow at least some of quaternary ammonium salt present in the carbonaceous adsorbent to dissolve in the regeneration liquid. The method further comprises a step of separating said regeneration liquid comprising dissolved quaternary ammonium salt from said carbonaceous adsorbent. The step of contacting the carbonaceous adsorbent with a liquid in which the quaternary ammonium salt has appreciable solubility may be continuous or batchwise. In a continuous regeneration process the regeneration liquid may be continuously passed through a bed of the carbonaceous adsorbent. Alternately, the regeneration may be carried out as a batch or semi-batch process in which the liquid is decanted or filtered away from the carbonaceous adsorbent. Further, continuous regeneration may be conducted in such a way that only fresh regeneration liquid is passed through the bed of carbonaceous adsorbent being regenerated. A fresh regeneration liquid is defined as a regeneration liquid which contains no QS. Alternatively, regeneration may be conducted in such a way that a batch of regeneration liquid is recirculated through the bed of carbonaceous adsorbent being regenerated. This recirculation technique may be repeated with a fresh charge of regeneration liquid until the concentration of QS in the regeneration liquid achieves a desirable level.

Suitable agents which may serve as the regeneration liquid are illustrated by solvents such as water, acetone, and methanol, and mixtures of solvents such as acetone and methanol with water. For example, aqueous methanol and aqueous acetone wherein the term “aqueous” means comprising from about 1 to about 99 percent by weight water.

In one embodiment, the carbonaceous adsorbent being regenerated is an activated carbon, the adsorbed quaternary ammonium salt is chloromethyltriethyl ammonium chloride, and the liquid is water.

In another embodiment of the present invention a pyrolyzed sulfonated polystyrene divinylbenzene resin that had been saturated with QS (chloromethyltriethyl ammonium chloride) is regenerated by treatment with water or another aqueous mixture at a temperature of from about 20 to about 100° C. and a pH of from about 1 to about 10. Alternatively, the resin could be regenerated with polar solvents such as acetone and methanol and mixtures of water with such polar solvents.

The regeneration may be conducted in a “once-through” mode or in a “batch recirculation” mode. The “once-through” regeneration mode is illustrated by passage of fresh regeneration liquid through a bed of brine polishing adsorbent. If the regeneration is conducted on resin that is packed in a column, the flow rate of regeneration liquid may be from about 0.1 to about 40 bed volumes per hour. Regeneration by “batch recirculation” is illustrated by simple recirculation of the regeneration liquid through the carbonaceous adsorbent. This recirculation of the regeneration liquid through the carbonaceous material undergoing regeneration may be continued over any time interval (e.g. from 1 hour to 24 hours) and at flow rates of from about 1 bed volume/hr to about 40 bed volumes/hr until a desired level of regeneration has been achieved

In one embodiment the present invention is a method for regenerating a carbonaceous adsorbent comprising one or more adsorbed quaternary ammonium salts, said method comprising the step of contacting the carbonaceous adsorbent with a liquid in which said quaternary ammonium is appreciably soluble, allowing at least some of the adsorbed quaternary ammonium salt to dissolve in the liquid, and separating said liquid comprising dissolved quaternary ammonium salt from said carbonaceous adsorbent.

It has been discovered further that carbonaceous adsorbents that have been exposed to phenolics, such as bisphenol A (BPA), show significant reductions in QS adsorption capacity. In another aspect of the present invention it has been found that a significant fraction of the carbonaceous adsorbent QS capacity may be restored by treatment with hot water, mild acid, or a polar solvent such methanol.

### EXAMPLES

The following examples are set forth to provide those of ordinary skill in the art with a detailed description of how the methods claimed herein are carried out and evaluated, and are not intended to limit the scope of what the inventors regard as their invention. Unless indicated otherwise, parts are by weight, temperature is in ° C.

Brine samples were purified by the method of the present invention and were then fed to a laboratory membrane electrolyzer where anode-to-cathode voltage measurements were made. The laboratory membrane electrolyzer comprised an EC300 anode (Eltech Corporation) and a nickel cathode. The cell was fitted with a DuPont NAFION membrane. The cell current was 3.5 KA/m². The brine feed was a 300 gpl (gram per liter) sodium chloride solution. The brine feed rate to the anode compartment was adjusted to yield 200 gpl NaCl anolyte product. The deionized water flow rate to the cathode compartment was adjusted to yield 33 wt % NaOH caustic product. The cell was operated at 90° C.

Cell voltage was measured for the membrane electrolyzer after the introduction of the respective solutions in the anode and cathode compartments, followed by application of electric current across the membrane electrolyzer. In Step (A) of each experimental run, an imino diacetic acid (IDA) functionalized ion exchange resin, IRC 748 (Rohm and Haas), was used for transition metal cation removal: In Step (b), an aminomethyl phosphonic acid (AMP) functionalized polystyrene resin ion exchange resin, DUOLITE C467 (Rohm and Haas), was used for “hardness removal”. In Step (c) a partially pyrolyzed polystyrene resin, AMBERSORB 572 (Rohm and Haas), was used for brine polishing which comprised removal of QS, “resin extract”, and other organic contaminants. “Resin extract” is believed to consist of contaminants introduced into the brine by contact with the ion exchange resin. While the effect of these contaminants (resin extract and other organic brine contaminants) is real and is manifested in the voltage penalty observed in the absence of a polishing step, neither the exact chemical nature or concentrations of these contaminants is precisely known. The results are summarized in the Table 1 below. The details of each test are described below.

All recycle brines were treated in a “primary brine treatment” step before being used according to the method of the present invention. In the primary brine treatment step, the brine pH was elevated to about 10 or above pH units in the presence of a molar excess of carbonate ion in order to precipitate alkaline earth and transition metals ions as their carbonates and/or hydroxides, followed by filtering or clarification. This was followed by acidification and stripping of the brine to remove carbonate ion as well as organic contaminants such as organic solvents and dissolved catalysts. The brine stripping step was carried out to remove volatile organics such as solvent from the recycle brine, and consisted of feeding brine to a packed tower and passing air up through the tower In general, the temperature for primary brine treatment is not critical, The preferred temperature range is from about 40° F. to about 120° F.

“Ultrapure” brine was prepared from Morton CULINOX 999 food grade salt that had been purified by “hardness removal ion exchange” at pH 9-11 at 2 bed volumes/hr, using ion exchange resin that had been regenerated at least once.

All test cells were conditioned by continuous operation with ultrapure brine until stable voltage readings were obtained. After conditioning, and without interrupting feeds to the cell, the brine source was switched from ultrapure brine to a test brine. The “cell voltage increase rate” was determined for each test brine by subtracting the voltage obtained with ultrapure brine from the voltage obtained after operating with the test brine, and dividing by the duration (hours) of the test.

Three brine purification sequences were utilized. The conditions for each sequence are given below:

Method 1:

A. AMBERSORB 572 (pH 3.5, 2 bed volumes/hr)

B. Transition Metal Cation Removal (pH 3.5, 2 bed volumes/hr)

C. Hardness Removal (pH 10.4, 2 bed volumes/hr)

Method 2:

A. AMBERSORB 572 (pH 3.5, 2 bed volumes/hr)

B. Transition Metal Cation Removal (pH 3.5, 2 bed volumes/hr)

C. Hardness Removal (pH 10.4, 2 bed volumes/hr)

D. AMBERSORB 572 (pH 10.4, 2 bed volumes/hr)

Method 3:

A. Transition Metal Cation Removal (pH 3.5, 2 bed volumes/hr)

B. Hardness Removal (pH 10.4, 2 bed volumes/hr)

C. AMBERSORB 572 (pH 3.5, 2 bed volumes/hr)

The results from Examples 1-4 are summarized in the Table 1 below.

TABLE 1

| | | ppm | | | |
|---|---|---|---|---|---|
| | | Sodium | | Voltage increase | |
| Example | Brine | Gluconate | Treatment | Rate | |
| 1 | Ultrapure | 0 | Method 1 | 4 | mV/hr |
| 1 | Ultrapure | 0 | Method 2 | 1 | mV/hr |
| 2 | Recycle | 350 | Method 1 | 18 | mV/day |
| 2 | Recycle | 350 | Method 2 | 4.6 | mV/day |
| 3A | Recycle | 250 | Method 1 | 64 | mV/hr |
| 3A | Recycle | 250 | Method 1 | 38 | mV/hr |
| 3A | Recycle | 250 | Method 1 | 15 | mV/hr |
| 3B | Recycle | 250 | Method 2 | 0.05 | mV/hr |
| 4 | Recycle | 100 | Method 3 | 0.2-0.3 | mV/hr |
| 4 | Recycle | 100 | Method 3 | 0.2-0.3 | mV/hr |

### Example 1

Gluconate-free, “clean” brine was prepared from Morton CULINOX 999 food grade salt and dionized water. Brine which is free of gluconate ions and is made from food grade salt and deionized water is referred to as “clean” brine. This brine was subjected to brine purification Method 1 using fresh ion exchange resins to yield a purified brine. The purified brine was then fed to a laboratory membrane electrolyzer that had been previously conditioned by operation with ultrapure brine. The cell voltage was 3.400 volts just prior to switching from ultrapure brine to the purified brine. After 23 hours of operation with the purified brine, the voltage had increased by 83 mV (4 mV/hr). The laboratory membrane electrolyzer cell was then switched to a feed of the purified brine which had been further subjected to treatment by passage through a bed of AMBERSORB 572 resin at pH 10.4 and a rate of 2 bed volumes/hr to give a “polished” brine. The purification and polishing steps used here constitute brine purification Method 2 which is said to afford a “polished” brine. The cell voltage for the brine treated using Method 2 increased from 3.400 volts to 3.428 volts after 24 hours (1 mV/hr).

Example 1 shows that even treatment of non-gluconate containing, non-recycle brine using brine purification Method 1 resulted in a significant voltage increase, despite the use of fresh ion exchange resins throughout. The voltage increase was significantly reduced when the brine purification Method included the brine polishing step using AMBERSORB 572 resin (Step D of Method 2). It is believed that the voltage increase is due to material that is extracted from the fresh ion exchange resin, most of which is removed in the brine polishing step.

### Example 2

“Recycle brine” containing 350 ppm sodium gluconate was treated using brine purification Method 1 and fed to a laboratory membrane electrolyzer cell. The voltage increase was 200 mV after 11 days of cell operation. The rate of voltage increase was about 20 mV per day. The recycle brine was then “polished” by passage through AMBERSORB 572 resin to afford a “polished recycle brine”. The polished recycle brine was fed to a laboratory membrane electrolyzer cell that had previously been exposed only to ultra-pure brine. The voltage increase after 11 days of cell operation with the polished recycle brine was only 51 mV.

### Example 3

(a) Cell Performance Using Method 1

Recycle brine containing 250 ppm sodium gluconate was treated using brine purification Method 1 to provide a purified recycle brine. Fresh resins were used in each ion exchange step. Both ion exchange resins employed were regenerated once prior to being placed into service for this test. The recycle brine purified by Method 1 was introduced into a laboratory membrane electrolyzer cell. The cell voltage was initially 3.311 volts. After 1.55 hours of operation with the purified recycle brine, the voltage had sharply increased to 3.410 volts (64 mV/hr). The cell was then returned to operation with ultrapure brine for 2.7 hours, whereupon the cell voltage decreased and stabilized at 3.380 volts. The feed was again switched and the purified recycle brine was fed to the cell. After 19.5 hours of operation the voltage was 3.678 volts, an increase of 298 mV (15 mV/hr). The cell was then returned to operation with ultrapure brine for 51.7 hours, during which time the cell voltage decreased and stabilized at 3.449 volts. The feed to the cell was again was switched to the purified recycle brine. After 1.2 hours, the voltage was 3.494 volts (38 mV/hr). These results show that the cell voltages consistently increased when recycle brine purified using brine purification Method 1 was fed to the cell, and that these voltage increases were significant.

(b) Cell Performance Using Method 2

The cell employed in Example 3(a) above was then returned to operation with ultrapure brine for 66 hours, whereupon the cell voltage decreased and stabilized at 3.358 volts. The purified recycle brine from Example 3(a) was further treated by passage through a bed of AMBERSORB 572 resin (Rohm and Haas Company) at a feed pH of 10 and a rate of 2 bed volumes per hour to afford a polished recycle brine. The combination of the steps of brine purification Method 1 with an additional following step of passage through AMBERSORB 572 constitutes brine purification Method 2. The polished recycle brine was fed to the cell. The voltage increased only 1 mV after 21 hours of operation to 3.359 volts. This demonstrated that “polishing” the purified recycle brine by treatment with AMBERSORB 572, eliminates the voltage increase observed when the recycle brine is purified by Method I.

### Example 4

Cell Performance Using Method 3

Test 1: Recycle brine containing 100 ppm sodium gluconate was purified by “primary brine treatment” followed by treatment using brine purification Method 3 to afford a polished recycle brine. The primary brine treatment was carried out as described in U.S. Pat. No. 6,103, 092. In a first test, ultrapure brine was fed to a laboratory membrane electrolyzer cell until the voltage reading was at a minimum and was stable. The polished recycle brine was then introduced into the cell. The voltage increased from 3.600 to 3.615 volts over a period of 2 days (0.3 mV/hr) (Cell I) Polished recycle brine was also introduced into a different but identically configured laboratory membrane electrolyzer cell (Cell II) which had been previously stabilized with ultrapure brine. Here, the voltage reading from Cell 11 increased from 3.551 to 3.559 volts over 2 days (0.2 mV/hr). In control experiments, over a two day time interval, Cell I being fed ultrapure brine showed a voltage decrease (-6 mV), and Cell II being fed ultrapure brine showed no change in voltage.

Test 2: Cells I and II were first fed ultrapure brine and subsequently the polished recycle brine prepared above. The voltage increased from 3.344 to 3.361 volts over a period of 4 days (0.17 mV/hr) of operation with polished recycle brine in Cell I. In Cell II the voltage increased from 3.287 to 3.316 volts over the same period (0.30 mV/hr) of operation with polished recycle brine. In control experiments using ultrapure brine, Cells I and II showed voltage increases of 9 and 21 mV (0.093 and 0.22 mV/hr) respectively over a 4 day period.

Regneration of Quaternary Ammonium Salt (QS) Adsorption Resins

### Examples 5-7

A polishing column was prepared as follows. A glass column having a 1 inch inner diameter was packed with 50 gm Rohm and Haas AMBERSORB 572 resin. The bed volume was 116 mL. Brine (23 wt % NaCl) containing QS was fed to the column at a constant flow rate. After the polishing column was saturated with QS, the brine stream was discontinued and a regenerant stream was fed to the column. The amount of QS recovered from the resin during regeneration was then measured.

After regeneration, the resin of the polishing column was placed back into QS adsorption service for another cycle. Table 2 shows the detailed operating conditions for several cycles. Weight percentages refer to weights of QS relative to the weight of dry resin.

TABLE 2
QS ADSORPTION AND REGENERATION CYCLES IN
POLISHING COLUMN

| | | | wt % QS | | | |
|---|---|---|---|---|---|---|
| | | [QS] | Loaded onto | | Regeneration | % QS recovered |
| Example | Cycle | ppm | Column | Regenerant | Mode | in Regeneration |
| 5 | 2 | 15.00 | 3.4 | Room Temp | A^{a} | 74% |
| | | | | 0.1 N HCl | | |
| 6 | 4 | 23.73 | 3.9 | 60° C. Water | B^{b} | 85% |
| | | | | 70° C. Water | | |
| 7 | 5 | 30.29 | 4.0 | 60° C. Water | B^{b} | 81% |
| | | | | 75° C. Water | | |

^{a}Continuous flow 5.9 bed vol per hour, 29.5 total bed volumes
^{b}Recirculation of 1 gal (32 bed volumes) of water for 24 hours; Recirculation of 2^{nd} gal water for 24 hours

These column tests of Examples 5-7 of Table 2 demonstrate that both water and 0.1 N HCl are effective for removing QS from a pyrolyzed polystyrene resin such as AMBERSORB 572.

### Example 8

### Batch Cycle Test

A single batch of resin was cycled multiple times through adsorption and desorption at 60° C. Thus, 260 gm brine (23 wt % NaCl and 44 ppm QS) and 260 mg of AMBERSORB 572 were placed in a 500 mL Erlenmeyer flask and agitated on an orbital shaker for 24 hours. The brine was then filtered from the resin and was found to contain 14.5 ppm residual QS. The resin thus adsorbed 3.1 wt % QS. Then the resin and 250 gm water were placed in an Erlenmeyer flask and agitated for 24 hours. The water was analyzed and found to contain 31.1 ppm QS (3.0 wt % vs resin). This cycle was repeated 17 times. On the 17th adsorption cycle, the brine QS level was reduced from 44 ppm to 18.1 ppm, which represents 2.6 wt % QS adsorption onto the resin. On the desorption cycle, 269 gm DI water was added to the resin. The DI water contained 29.7 ppm QS after 24 hours, which is equivalent to 3.0 wt % QS. Thus, the resin is effective for multiple cycles of QS adsorption and desorption using water as the regeneration medium.

### Examples 9-14

### Alternate Regeneration Schemes

A bed of AMBERSORB 572 was exposed to brine which contained 5-15 ppm BPA in addition to 20-30 ppm QS and then regenerated as in Example 6. It is believed that BPA is strongly bound to AMBERSORB 572 resin and interferes with the QS binding capacity of AMBERSORB 572. Following regeneration using water as the regeneration liquid the resin was again exposed to brine containing 5-15 ppm BPA and 20-30 ppm QS until the resin was saturated with QS. The resin was again regenerated as in Example 6. After 4 such adsorption and desorption cycles, the resin showed no capacity to adsorb QS from brine. The resin was then subjected to several types of treatments to restore QS adsorption activity. The temperature for all treatments and capacity tests was 60° C. unless noted otherwise. In each test, 250 mg of contaminated resin and 100 gm of regeneration liquid were charged to a 250 mL Erlenmeyer flask. The flask was agitated on an orbital shaker for 4 hours, after which the resin was filtered from the treatment liquid and tested for QS capacity according to the method of Example 8. Table 3 below shows that hot water, mild acid, and methanol treatments are effective for restoring a significant fraction of the original resin QS capacity. It is noted that the mild caustic treatment is only slightly effective for restoring QS capacity.

TABLE 3
RESTORING QS CAPACITY OF “POLISHING” RESIN EXPOSED
TO BISPHENOL A

| | | wt % QS Capacity |
|---|---|---|
| Example No. | Resin Treatment | After Treatment |
| CE- | Control (New Resin) | 3.53 |
| Example 9 | Hot Water (100° C.) | 1.65 |
| Example 10 | 0.5 M NaOH | 0.53 |
| Example 11 | 0.5 M HCl | 1.66 |
| Example 12 | Acetone | 1.16 |
| Example 13 | 10% Acetone in Water | 0.52 |
| Example 14 | Methanol | 1.58 |

The data in Table 3 illustrate that the resin employed in the QS removal and brine polishing step may be restored using in any of the “resin treatments” indicated. Interestingly, treatment with hot water is among the most effective means of restoring the resin.

The invention has been described in detail with particular reference to preferred embodiments thereof, but it will be understood by those skilled in the art that variations and modifications can be effected within the spirit and scope of the invention.

What is claimed is:

1. A method for removing impurities from a brine solution, said brine solution comprising a water soluble chelating agent, the method comprising the steps
a) adjusting the pH of the brine solution to a pH of from about 2 to about 4 and passing the brine solution through a first functionalized resin; said first functionalized resin having functional groups capable of removing transition metal cations from the brine solution;
b) adjusting the pH of the brine solution to a pH of from about 9 to about 11.5 and passing the brine solution through a second functionalized resin, said second functionalized resin having functional groups capable of removing alkaline earth metal cations from the brine solution; and
c) objecting the brine solution to a polishing step following step b).

2. The method of claim 1, further comprising the step of subjecting the brine solution in a primary brine treatment step, prior to step a).

3. The method of claim 1, wherein the first functionalized resin removes iron, nickel, chromium, aluminum ions or mixtures thereof.

4. The method of claim 1, wherein the second functionalized resin removes calcium, magnesium, barium, strontium ions or mixtures thereof

5. The method of claim 1, wherein the polishing step following step b) [symbol] tment of the brine solution with a partially pyrolyzed sulfonated polystrene divinylbenzene resin.

6. The method of claim 1, wherein the polishing step following step c) [symbol] ment of the brine solution with in a carbon bed.

7. The method of claim 1, further comprising the step of recovering the brine solution.

8. The method of claim 1, wherein the first functionalized resin is an imino diacetic acid functionalized ion exchange resin.

9. The method of claim 1, wherein the second functionalized resin is an amino methyl phosphonic acid functionalized ion exchange resin.

10. The method of claim 1, wherein the brine solution in step c) is passed the second functionalized resin at a space velocity of from about 1 to about 30 times per hour.

11. The method of claim 10, wherein the temperature of the brine solution [symbol] about 20° C. to about 90° C.

12. The method of claim 1, wherein the brine solution in step b) is passed [symbol] the second functionalized resin at a space velocity of from about 1 to about 30 [symbol] umes per hour.

13. The method of claim 12, wherein the temperature of the brine solution [symbol] ge between about 20° C. and about 90° C.

14. A method for removing impurities from a brine solution, said brine [symbol] comprising sodium gluconate and chloromethyltriethyl ammonium chloride, [symbol] hod comprising the steps of:
a) adjusting the pH of the brine solution to a pH of from about 2 to about 4 and passing the brine solution through a first functionalized resin; said first functionalized resin having functional groups capable of removing transition metal cations from the brine solution;
b) adjusting the pH of the brine solution to a pH of from about 9 to about 11.5 and passing the brine solution through a second functionalized resin, said second functionalized resin having functional groups capable of removing alkaline earth metal cations from the brine solution; and
c) subjecting the brine solution to a polishing step following step b).

15. The method of claim 14, further comprising the step of subjecting the brine solution in a primary brine treatment step, prior to step a).

16. The method of claim 15, wherein the first functionalized resin removes iron, nickel, chromium, aluminum ions or mixtures thereof.

17. The method of claim 16, wherein the second functionalized resin remove [symbol] calcium, magnesium, barium, strontium ions or mixtures thereof

18. The method of claim 17, wherein the polishing step c) following step b) comprises treatment of the brine solution with a partially pyrolyzed sulfonated poly [symbol] ene resin.

19. The method of claim 17, wherein the polishing step c) following step b) comprises treatment of the brine solution with in a carbon bed.

20. The method of claim 14, further comprising the step of recovering the brine solution.

21. The method of claim 14, wherein the first functionalized resin is an im [symbol] etic acid functionalized ion exchange resin.

22. The method of claim 14, wherein the second functionalized resin is an am [symbol] methyl phosphonic acid functionalized ion exchange resin.

23. The method of claim 14, wherein the brine solution in step b) is passed through the second functionalized resin at a space velocity of from about 1 to about 30 [symbol] volumes per hour.

24. The method of claim 23, wherein the temperature of the brine solution is from about 20° C. to about 90° C.

25. The method of claim 14, wherein the brine solution in step a) is passed through the first functionalized resin at a space velocity of from about 1 to about 30 bed volumes per hour.

26. The method of claim 25, wherein the temperature of the brine solution is in a range between about 20 and about 90° C.

27. A method for regenerating a carbonaceous adsorbent comprising one or more adsorbed quaternary ammonium salts, said method comprising the step of contacting the carbonaceous adsorbent with a liquid in which said quaternary ammonium is appreciably soluble, allowing at least some of quaternary ammonium salt to dissolve in the liquid, and separating said liquid comprising dissolved quaternary ammonium salt from said carbonaceous adsorbent.

28. A method according to claim 27 wherein said liquid is selected from the group consisting of selected from the group consisting of water, aqueous methanol, aqueous acetone, acetone, and methanol.

29. A method according to claim 27 wherein said quaternary ammonium salt is chloromethyltriethyl ammonium chloride.
